(19) United States
(12) Patent Application Publication
(10) Pub. No.: US 2008/0135338 A1
(43) Pub. Date: Jun. 12, 2008

(54) Pneumatic tool

(75) Inventors: Yuan-Ching Lin, Taipei (TW); Min-Chih Wen, Taipei County (TW)

Correspondence Address: BACON & THOMAS, PLLC, 625 SLATERS LANE, FOURTH FLOOR, ALEXANDRIA, VA, 22314, US

(73) Assignee: National Taiwan University of Science and Technology, Taipei (TW)

(21) Appl. No.: 11/898,392

(22) Filed: Sep. 12, 2007

(30) Foreign Application Priority Data
Dec. 8, 2006 (TW) 95146058

(51) Int. Cl. F16N 15/02; B23Q 11/12; F16N 25/04

(52) U.S. Cl. 184/6.14; 184/100

(57) ABSTRACT

A pneumatic tool includes a housing of a cylinder, a rotor and at least a blade. The housing of the cylinder has an inner wall. The rotor is disposed inside the housing of the cylinder. The rotor has at least a slit. The blade is movably inserted into the slit. The blade includes a solid lubricant, at least an oil-bearing trough and a counterweight. The solid lubricant is disposed on a contacting surface near the inner wall. When the blade is flung out from the slit, the solid lubricant is against the inner wall. The oil-bearing trough is disposed on the contacting surface for storing oil to lubricate the contacting surface and the inner wall. The counterweight is disposed inside the blade near the inner wall for increasing a force to fling the blade out from the slit.

This application claims the benefit of Taiwan application Serial No. 95146058, filed Dec. 8, 2006, the subject matter of which is incorporated herein by reference.

### BACKGROUND OF THE INVENTION

1. Field of the Invention

The invention relates in general to a pneumatic tool, and more particularly to a pneumatic tool with a movable blade for driving the rotation of a rotor.

2. Description of the Related Art

General power tools include electric tools and pneumatic tools. Electric tools are powered by electricity. Pneumatic tools are powered by high-pressure air. Pneumatic tools have high torsion strength and therefore are widely applied to construction industry or car industry.

Please refer to FIGS. 1˜2. FIG. 1 illustrates a conventional pneumatic tool 900. FIG. 2 is an exploded view of the pneumatic tool 900 in FIG. 1. The pneumatic tool 900 in FIG. 1 is a pneumatic wrench for example. The pneumatic tool 900 includes a housing 910 of a cylinder, a rotor 920 and at least a blade 930. The rotor 920 and the blade 930 are disposed inside the housing 910 of the cylinder. The blade 930 is movably inserted into a slit 921 of the rotor 920. When high-pressure air is injected into the housing 910 of the cylinder, high-pressure air pushes the blade 930 to drive the rotor 920 to rotate. Meanwhile, the blade 930 is flung from the slit 921 by a centrifugal force and against an inner wall 910a of the housing 910 of the cylinder. The blade 930 is pushed by the high-pressure air and drives the rotor 920 and the wrench (not shown in FIG. 2) to rotate rapidly.

However, the conventional pneumatic tool still has following disadvantages.

First, the blade is worn out seriously. When the blade and rotor rotate, the blade is flung out from the slit and against the inner wall of the housing of the cylinder. After operating for a while, the blade is usually worn out seriously.

Second, the service life of the pneumatic tool is shortened. Wearing out of the blade is the main reason why the pneumatic tool fails. The blade is worn out frequently, so the service life of the pneumatic tool is shortened accordingly.

Third, the starting speed is slow, or the pneumatic tool cannot even be started. As stated above, conventionally for reducing the friction between the blade and the housing of the cylinder, oil is injected into the housing of the cylinder along with the high-pressure air. After the pneumatic tool operates for a while, oil dirt is accumulated in the slit. As a result, the blade is restricted when flung out, which causes low starting speed. When restricted seriously, the blade cannot slide out the slit and the pneumatic tool cannot be started.

Therefore, it is very important to provide a pneumatic tool to solve the above problems.

### SUMMARY OF THE INVENTION

The invention is directed to a pneumatic tool including a solid lubricant, an oil-bearing trough and a counterweight for increasing the lubricity between a blade and an inner wall of a housing of a cylinder. The centrifugal force to fling the blade out from the slit is increased. Therefore, the pneumatic tool of the present invention has following advantages. The wearing out of the pneumatic tool is alleviated. The service life of the pneumatic tool is increased. Also, the pneumatic tool is started smoothly.

According to the present invention, a pneumatic tool including a housing of a cylinder, a rotor and at least a blade is provided. The housing has an inner wall. The rotor is disposed inside the housing. The rotor has at least a slit. The blade is movably inserted into the slit. The blade includes a solid lubricant disposed on a contacting surface near the inner wall. When the blade is flung out from the slit, the solid lubricant is against the inner wall.

According to the present invention, another pneumatic tool including a housing of a cylinder, a rotor and at least a blade is provided. The housing of the cylinder has an inner wall. The rotor is disposed inside the housing and has at least a trough. The blade is movably inserted into the slit. The blade includes at least an oil-bearing trough disposed on a contacting surface near the inner wall. The oil-bearing trough is for storing oil to lubricating the contacting surface and the inner wall.

According to the present invention, another pneumatic tool including a housing of a cylinder, a rotor and at least a blade is provided. The housing of the cylinder has an inner wall. The rotor is disposed inside the housing. The rotor has at least a slit. The blade is movably inserted into the slit and includes a counterweight disposed on the blade near the inner wall. The counterweight is for increasing a force to fling the blade out from the slit.

The invention will become apparent from the following detailed description of the preferred but non-limiting embodiments. The following description is made with reference to the accompanying drawings.

### BRIEF DESCRIPTION OF THE DRAWINGS

FIG. 1 illustrates a conventional pneumatic tool;

FIG. 2 is an exploded view of the pneumatic tool in FIG. 1;

FIG. 3 is an exploded view of a pneumatic tool according to a first embodiment of the present invention;

FIG. 4 is an exploded view of a pneumatic tool according to a second embodiment of the present invention;

FIG. 5 illustrates a blade with another oil-bearing trough;

FIG. 6 illustrates a blade with another oil-bearing trough;

FIG. 7 is an exploded view of a pneumatic tool according to a third embodiment of the present invention;

FIG. 8 is an exploded view of a pneumatic tool according to a fourth embodiment of the present invention;

FIG. 9 is an exploded view of a pneumatic tool according to a fifth embodiment of the present invention;

FIG. 10 is an exploded view of a pneumatic tool according to a sixth embodiment of the present invention; and

FIG. 11 is an exploded view of a pneumatic tool according to a seventh embodiment of the present invention.

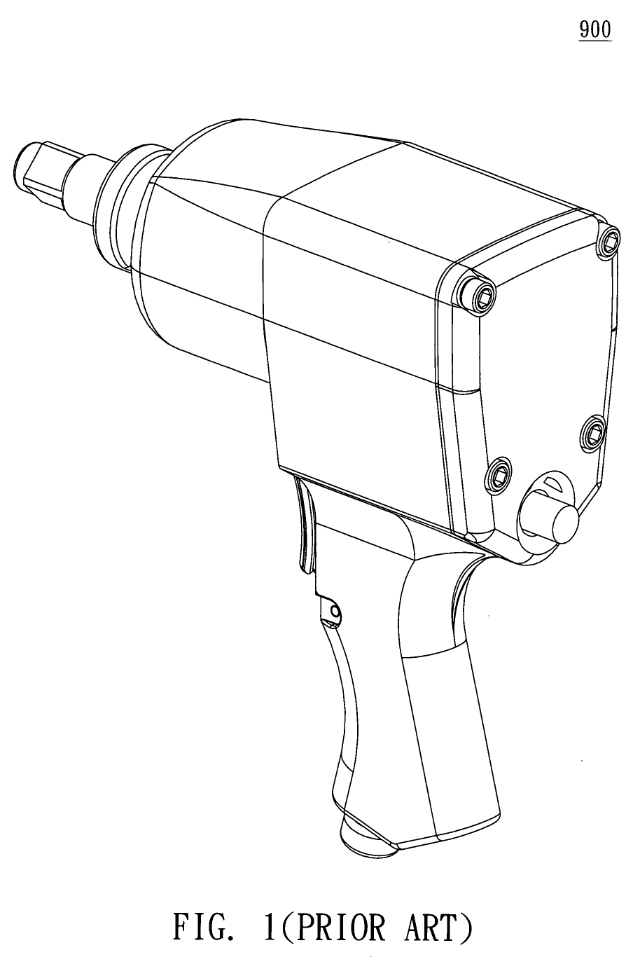

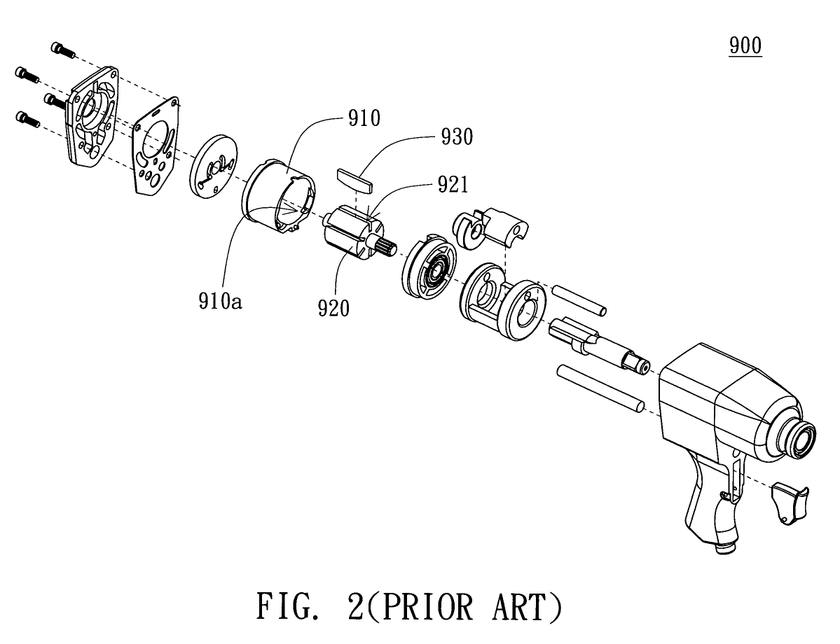

### DETAILED DESCRIPTION OF THE INVENTION

### First Embodiment

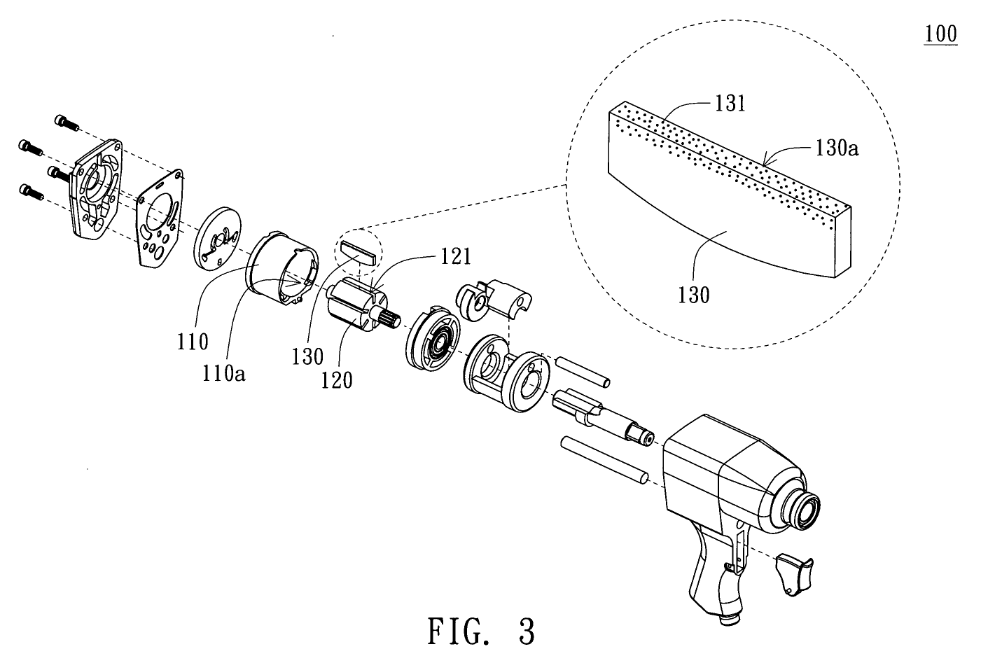

FIG. 3 is an exploded view of a pneumatic tool 100 according to a first embodiment of the present invention. Please referring to FIG. 3, the pneumatic tool 100 includes a housing 110 of a cylinder, a rotor 120 and at least a blade 130. The housing 110 of the cylinder has an inner wall 110a. The rotor 120 is disposed inside the housing of the cylinder 110. The rotor 120 has at least a slit 121. The blade 130 is movably inserted in the slit 121. In the present embodiment, the blade 130 includes a solid lubricant 131 disposed on a contacting surface 130a near the inner wall 110a. When the blade 130 is flung out from the slit 121, the solid lubricant 131 is against the inner wall 110a. The friction between the blade 130 and the inner wall 110a is reduced significantly by the solid lubricant 131.

The pneumatic tool 100 in FIG. 3 is a pneumatic wrench for example. However, the present invention is not limited thereto. The design of the present invention can also be applied to other types of the pneumatic tools.

According to the physical conditions, the lubricant can be generally divided into four groups, including solid lubricant, gaseous lubricant, liquid lubricant and semi-solid lubricant. Solid lubricant is solid for reducing friction between two surfaces which contact and move relatively to each other. Solid lubricant is divided into four types, structural solid lubricant, mechanical solid lubricant, soap solid lubricant and chemically active solid lubricant. The solid lubricant is for building a continuous and adhesive film on the friction surface. The film is hard or soft. The film can be formed through a mechanical, chemical, electro-chemical or physical process, such as dropping, coating, paint spraying, soaking, electrolyzing, electrophoresis, sinter, curing or spraying. Graphite, molybdenum disulfide (MoS₂) or poly-tetrafluoroethylene (PTEE) is the most commonly used as solid lubricant.

Graphite is slippery and black glossy solid. Graphite is ground into fine powders when used as solid lubricant. Graphite powders are strongly adhered to the contacting surface 130a of the blade 130 and effectively fill in minor dents of the contacting surface 130a. Therefore, the blade 130 operates steady with less noise, and the wearing out of the blade 130 is alleviated. Graphite is divided into natural graphite and artificial graphite. Natural graphite is flaky or has no specific shape. Natural graphite comes from underground mines. Artificial graphite is formed by coke processed under high temperature. Graphite powders have high temperature resistance. When used in the air, graphite powders are not oxidized even at 400° C. (752° F.). When the temperature is higher than 400° C., only carbon dioxide, which is not poison and has no harm, is produced by graphite powders.

Molybdenum disulfide is an inorganic substance and blue-black flake crystal. At 350° C., the oxidization of molybdenum disulfide is not obvious. No matters in air, moisture or vacuum, molybdenum disulfide can lubricate the mechanical components effectively.

Poly-tetrafluoroethylene is the lubricant with high temperature resistance. The slippery property of poly-tetrafluoroethylene depends on its chemical properties and the substance that poly-tetrafluoroethylene is polymerized with. The bearing capacity is relative to heat dissipation. The friction property of poly-tetrafluoroethylene is not affected by temperature significantly. When molybdenum disulfide, graphite and metal powders are added, the friction property and the hardness of polymers are improved. Also, graphite can increase the elasticity of poly-tetrafluoroethylene.

There are many types of solid lubricants. The user can choose a proper solid lubricant according to the application environment, manufacturing cost or manufacturing convenience.

As shown in FIG. 3, when the blade 130 is flung out from the slit 121, the solid lubricant 131 of the blade 130 is against the inner wall 110a of the housing 110 of the cylinder. Through the lubrication of the solid lubricant 131, the friction between the contacting surface 130a and the inner wall 110a is reduced effectively. Therefore, the blade 130 is prevented from being worn out, and the service life of the pneumatic tool 100 is increased.

### Second Embodiment

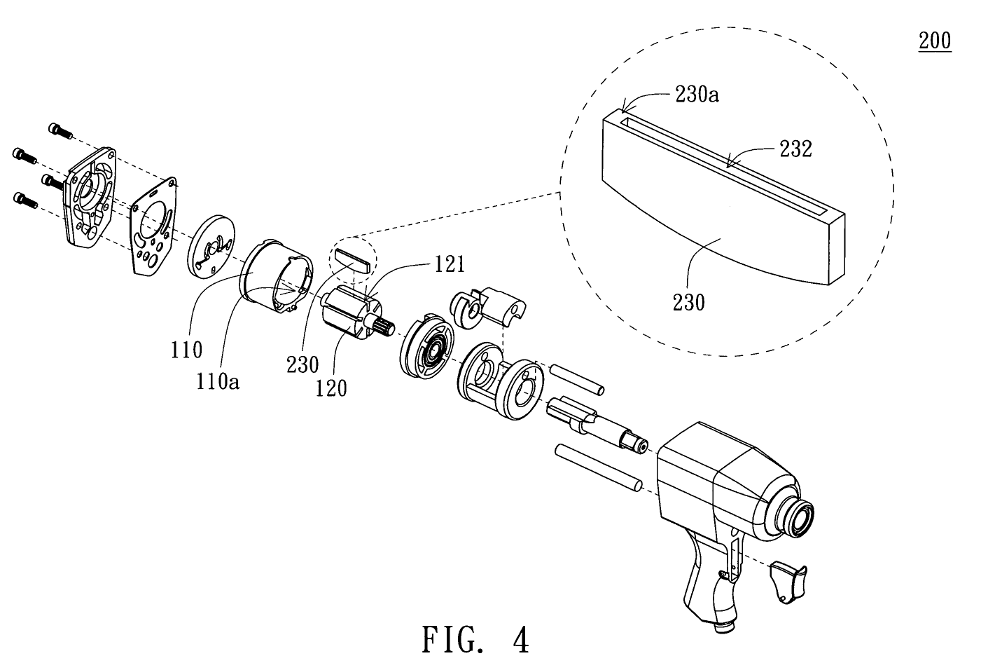

The pneumatic tool 200 of the present embodiment and the pneumatic tool 100 of the first embodiment are different in the structural design of the blade 230. Other parts are the same and not described repeatedly. Please refer to FIG. 4. FIG. 4 is an exploded view of the pneumatic tool 200 according to the second embodiment of the present invention. In the present invention, the blade 230 includes at least an oil-bearing trough 232. The oil-bearing trough 232 is formed on the contacting surface 230a adjacent to the inner wall 110a for storing oil to lubricate the contacting surface 230a and the inner wall 110a. Take FIG. 4 for example. The oil-bearing trough 232 is rectangular and positioned at the center of the contacting surface 230a. Also, the oil-bearing trough 232 occupies most of the contacting surface 230a.

When oil is sprayed into the housing 110 of the cylinder along with the high-pressure air, part of the oil is stored in the oil-bearing trough 232. As a result, when the contacting surface 230a of the blade 230 is against the inner wall 110a of the housing 110 of the cylinder, the oil oozes between the contacting surface 230a and the inner wall 110a. The friction between the blade 230 and the inner wall 110a is reduced.

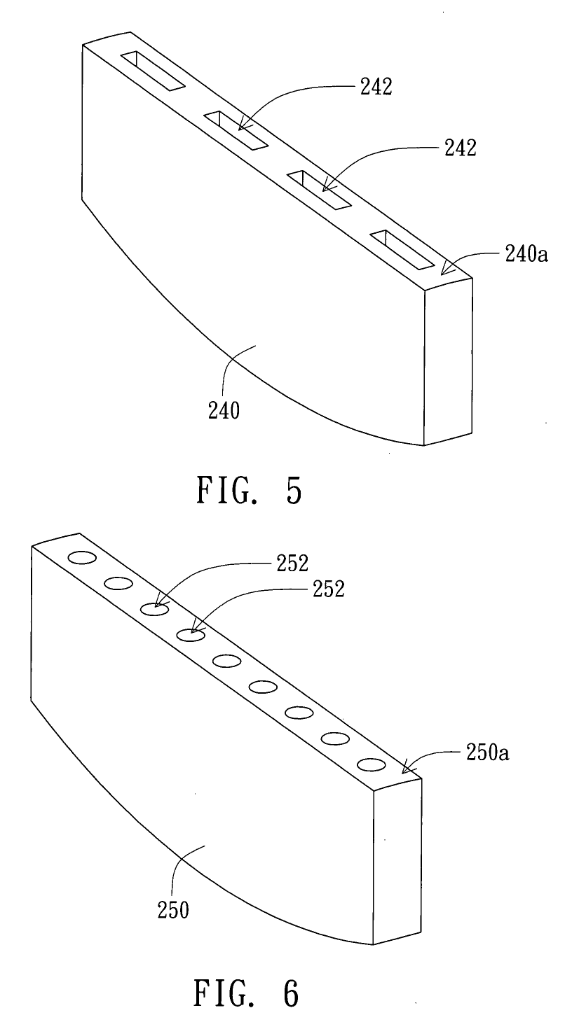

However, the oil-bearing trough 232 is not limited thereto. FIG. 5 and FIG. 6 show other two designs of the oil-bearing trough.

Please refer to FIG. 5. FIG. 5 illustrates the blade 240 with another oil-bearing trough 242. The blade 240 includes several oil-bearing troughs 242 instead of one oil-storing trough 242. As shown in FIG. 5, the oil-bearing troughs 242 are distributed evenly on the contacting surface 240a. In other words, some part of the structure of the blade 240 is between the adjacent oil-bearing troughs 242. Accordingly, the structural strength of the blade 240 is not lowered, and the oil is still stored on the contacting surface 240a.

FIG. 6 illustrates the blade 250 with another oil-bearing trough 252. In FIG. 4 and FIG. 5, the oil-bearing troughs 232 and 242 are rectangular. In FIG. 6, the oil-bearing trough 252 is a round structure and occupied more area of the contacting surface 250a. Generally speaking, the oil-bearing trough 232 has better lubricity when occupying more area. Furthermore, when having more structures, the blade has higher structural strength. The designer can decide the shape, number and position of the oil-bearing trough according to the demand for lubricity and the structural strength of the blade.

### Third Embodiment

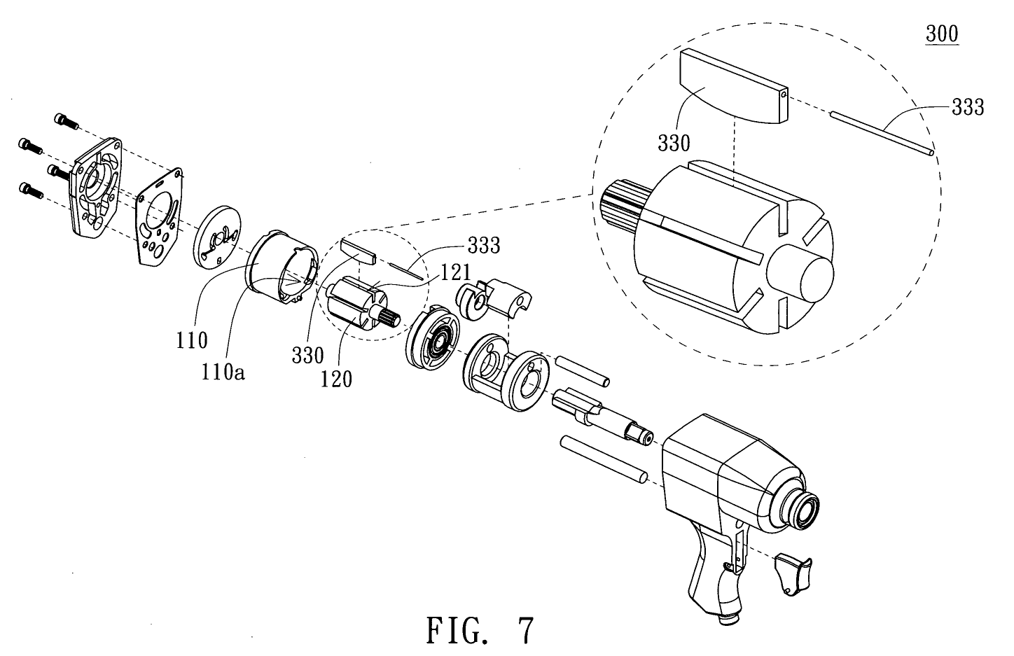

The pneumatic tool 300 of the present embodiment and the pneumatic tool 100 of the first embodiment are different in the structural design of the blade 330. Other parts are the same and not described repeatedly. Please refer to FIG. 7. FIG. 7 is an exploded view of the pneumatic tool 300 according to the third embodiment of the present invention. In the present embodiment, the blade 330 includes a counterweight 333 disposed inside the blade 330 adjacent to the inner wall 110a. The counterweight 333 is for increasing the force to fling the blade 330 out from the slit 121.

The specific weight of the counterweight 333 is higher than that of the blade 330. Therefore, when the high-pressure air pushes the blade 330 with some oil remaining in the slit 121, the counterweight 333 can generate a sufficient centrifugal force rapidly. As a result, the blade 330 slides out from the slit 121 accordingly. The blade 330 is prevented from being restricted by oil dirt and from being unable to slide out the slit. Also, the starting speed is increased.

Moreover, the counterweight 330 is a long pillar as shown in FIG. 7. The counterweight 333 is distributed evenly in the blade 330 adjacent to the inner wall 110a. Therefore, when the blade 330 rotates, the counterweight 333 generates even centrifugal force.

### Fourth Embodiment

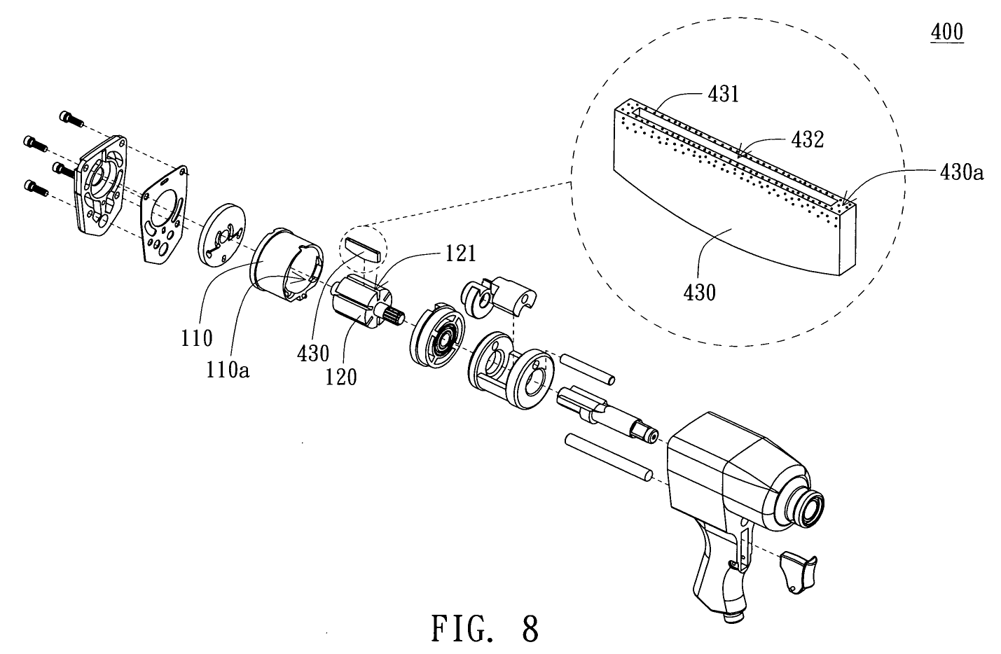

The pneumatic tool 400 of the present embodiment and the pneumatic tool 100 of the first embodiment are different in the structural design of the blade 430. Other parts are the same and not described repeatedly. Please refer to FIG. 8. FIG. 8 is an exploded view the pneumatic tool 400 according to the fourth embodiment of the present invention. In the present embodiment, the blade 430 includes not only the solid lubricant 431 but also at least an oil-bearing trough 432. The oil-bearing trough 432 occupies part of the contacting surface 430a. The solid lubricant 431 is disposed on the rest of the contacting surface 430a. The disposition of the oil-bearing trough 432 and the solid lubricant 431 is compatible with each other. Also, the oil-bearing trough 432 and the solid lubricant 431 working together increase the lubricity between the blade 430 and the inner wall 110a of the housing 110 of the cylinder.

### Fifth Embodiment

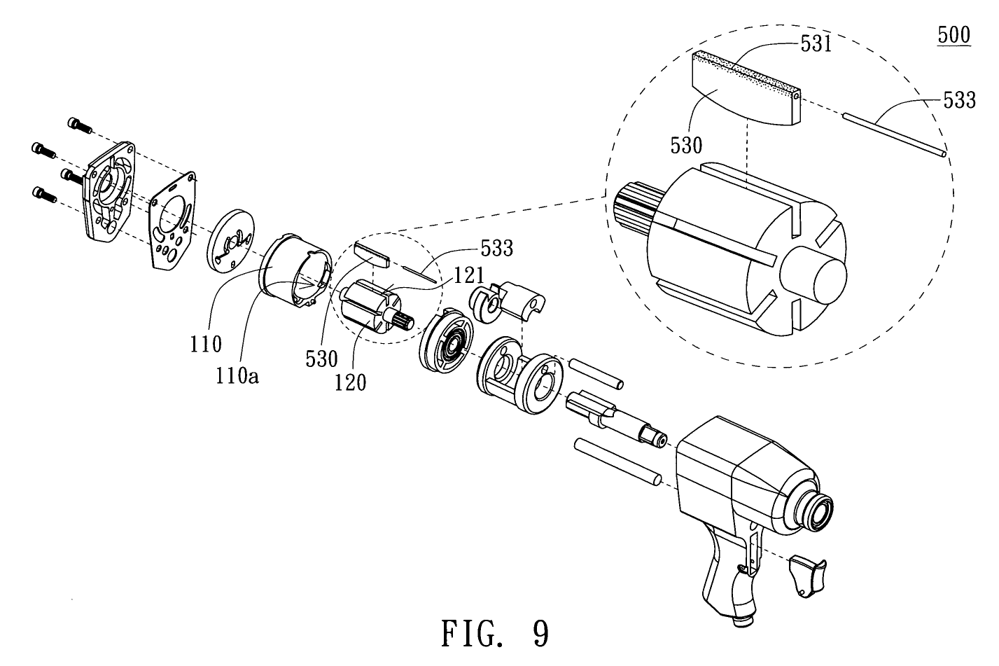

The pneumatic tool 500 of the present embodiment and the pneumatic tool 100 of the first embodiment are different in the structural design of the blade 530. Other parts are the same and not described repeatedly. Please refer to FIG. 9. FIG. 9 is an exploded view of the pneumatic tool 500 according to the fifth embodiment of the present invention. In the present embodiment, the blade 530 includes not only the solid lubricant 531 but also the counterweight 533. The counterweight 533 is disposed inside the blade 530 and does not affect the disposition of the solid lubricant 531. Through the counterweight 533 and the solid lubricant 531, the solid lubricant 531 maintains the lubricity between the blade 530 and the inner wall 110a when the counterweight 533 increases the centrifugal force.

### Sixth Embodiment

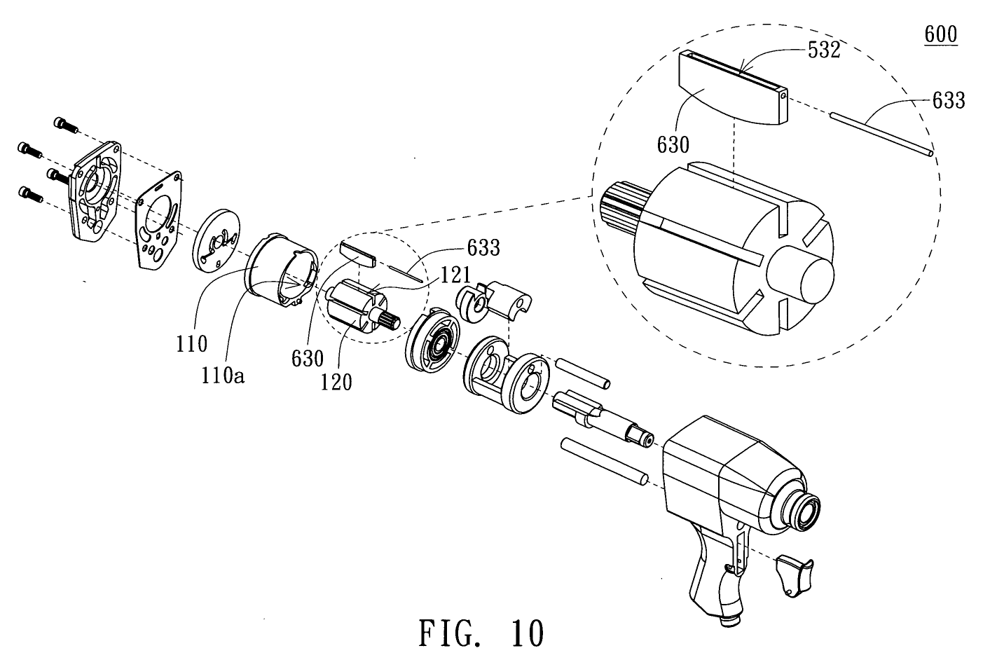

The pneumatic tool 600 of the present embodiment and the pneumatic tool 200 of the second embodiment are different in the structural design of the blade 630. Other parts are the same and not described repeatedly. Please refer to FIG. 10. FIG. 10 is an exploded view of the pneumatic tool 600 according to the sixth embodiment of the present invention. In the present embodiment, the blade 630 includes not only the oil-bearing trough 532 but also the counterweight 633. The counterweight 633 is disposed inside the blade 630 and does not affect the structure of the oil-bearing trough 532. Even when the oil-bearing trough 532 exposes part of the counterweight 633, the function of the oil-bearing trough 532 and the counterweight 633 is not affected.

### Seventh Embodiment

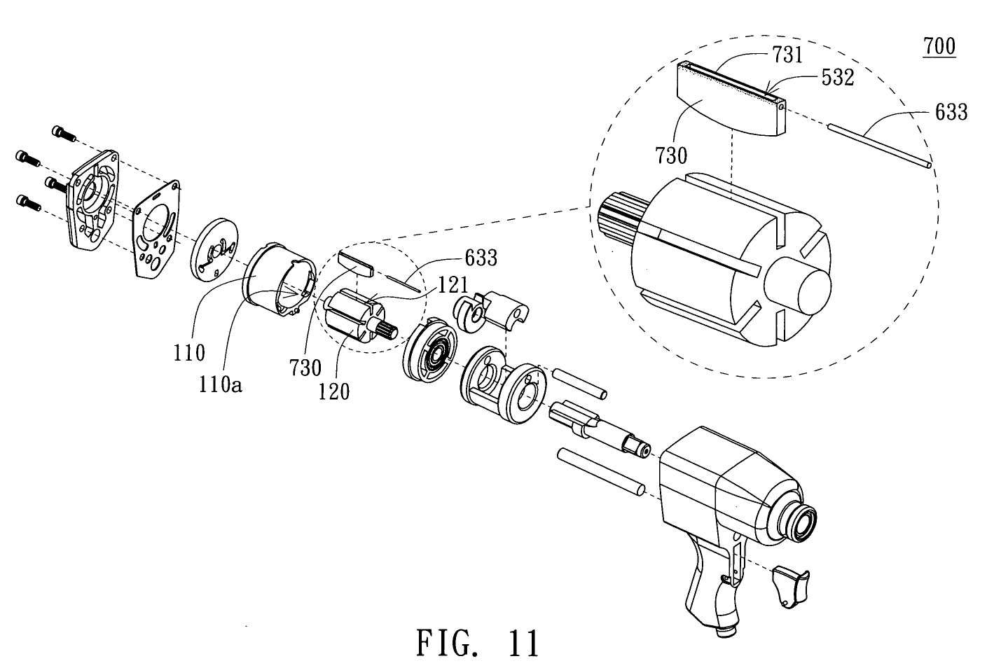

The pneumatic tool 700 of the present embodiment and the pneumatic tool 600 of the sixth embodiment are different in the structural design of the blade 730. Other parts are the same and not described repeatedly. Please refer to FIG. 11. FIG. 11 is an exploded view of the pneumatic tool 700 according to the seventh embodiment of the present invention. In the present embodiment, the blade 730 includes the oil-bearing trough 532, the counterweight 633 and the solid lubricant 731. As stated above, the disposition of the oil-bearing trough 532, the counterweight 633 and the solid lubricant 731 is compatible with each other. The designer can decide the combination thereof for achieving the purpose of the present invention.

In the pneumatic tools revealed in the above embodiments, the solid lubricant, the oil-bearing trough and the counterweight are used for increasing the lubricity between the blade and the inner wall and increasing the centrifugal force to fling the blade out from the slit. The pneumatic tool of the embodiments of the present invention includes following advantages.

First, the wearing-out of the blade is alleviated. After the blade is flung out from the slit, the solid lubricant is against the inner wall. Through the solid lubricant, the friction between the contacting surface and the inner wall is reduced. Besides, the oil-bearing trough is formed in the blade for storing oil. A certain amount of the oil remains between the contacting surface and the inner wall. Therefore, the wearing out of the blade is effectively alleviated.

Second, the service life of the pneumatic tool is increased. The main reason why the pneumatic tool fails is wearing out of the blade. Therefore, when the structural design of the present invention alleviates the wearing out of the blade, the service life of the pneumatic tool is prolonged.

Third, it is easy to start the pneumatic tool. The counterweight is disposed within the blade near the inner wall. When the blade is started, the counterweight increases the centrifugal force to fling the blade. The blade is prevented from being restricted by oil dirt. Therefore, the starting speed of the pneumatic tool is increased. Also, the problem that the pneumatic tool cannot be started is solved.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A pneumatic tool comprising:
a housing of a cylinder having an inner wall;
a rotor disposed inside the housing of the cylinder, the rotor having at least a slit; and
at least a blade movably inserted into the slit and comprising:
a solid lubricant disposed on a contacting surface adjacent to the inner wall; when the blade is flung out from the slit, the solid lubricant is against the inner wall.

2. The pneumatic tool according to claim 1, wherein the material of the solid lubricant is graphite, molybdenum disulfide (MoS₂) or poly-tetrafluoroethylene (PTFE).

3. The pneumatic tool according to claim 1, wherein the blade further comprises:
at least a oil-bearing trough disposed on the contacting surface for storing oil to lubricate the contacting surface and the inner wall.

4. The pneumatic tool according to claim 3, wherein the blade comprises a plurality of oil-bearing troughs distributed evenly on the contacting surface.

5. The pneumatic tool according to claim 3, wherein the oil-bearing troughs are rectangular structures or round structures.

6. The pneumatic tool according to claim 3, wherein the blade further comprises:
a counterweight disposed on the blade near the inner wall, for increasing a force to fling the blade out from the slit.

7. The pneumatic tool according to claim 6, wherein the counterweight is a long pillar distributed evenly inside the blade near the inner wall.

8. The pneumatic tool according to claim 6, wherein the specific weight of the counterweight is higher than the specific weight of the blade.

9. The pneumatic tool according to claim 1, wherein the blade further comprises:
a counterweight disposed inside the blade near the inner wall, for increasing a force to fling the blade out from the slit.

10. The pneumatic tool according to claim 9, wherein the counterweight is a long pillar disposed evenly inside the blade near the inner wall.

11. The pneumatic tool according to claim 9, wherein the specific weight of the counterweight is higher than the specific weight of the blade.

12. A pneumatic tool comprising:
a housing of a cylinder having an inner wall;
a rotor disposed inside the housing and having at least a slit; and
at least a blade movably inserted into the slit and comprising:
at least a oil-bearing trough disposed on a contacting surface near the inner wall for storing oil to lubricate the contacting surface and the inner wall.

13. The pneumatic tool according to claim 12, wherein the blade comprises a plurality of oil-bearing troughs evenly distributed on the contacting surface.

14. The pneumatic tool according to claim 12, wherein the oil-bearing troughs are rectangular structures or round structures.

15. The pneumatic tool according to claim 12, wherein the blade further comprises:
a counterweight disposed inside the blade near the inner wall for increasing a force to fling the blade out from the slit.

16. The pneumatic tool according to claim 15, wherein the counterweight is a long pillar evenly distributed inside the blade near the inner wall.

17. The pneumatic tool according to claim 15, wherein the specific weight of the counterweight is larger than the specific weight of the blade.

18. A pneumatic tool comprising:
a housing of a cylinder having an inner wall;
a rotor disposed inside the housing of the cylinder and having at least a slit; and
at least a blade movably inserted into the slit and comprising:
a counterweight disposed inside the blade near the inner wall, for increasing a force to fling the blade out from the slit.

19. The pneumatic tool according to claim 18, wherein the counterweight is a long pillar distributed evenly inside the blade near the inner wall.

20. The pneumatic tool according to claim 19, wherein the specific weight of the counterweight is larger than the specific weight of the blade.
